(19) United States
(12) Patent Application Publication
(10) Pub. No.: US 2013/0312568 A1
(43) Pub. Date: Nov. 28, 2013

(54) HEATING PAINT COATING METHOD FOR STEERING WHEEL AND STEERING WHEEL MADE BY THE SAME

(71) Applicant: Tae Soo Kim, Ulsan (KR)

(72) Inventor: Tae Soo Kim, Ulsan (KR)

(73) Assignee: LG HAUSYS, LTD., Seoul (KR)

(21) Appl. No.: 13/989,014

(22) PCT Filed: Nov. 26, 2010
(86) PCT No.: PCT/KR2010/008436

§ 371 Date: Aug. 7, 2013

(51) Int. Cl. B62D 1/06

(52) U.S. Cl. CPC B62D 1/065
USPC 74/558; 427/256

(57) ABSTRACT

Disclosed is a heating paint coating method for steering wheel and a steering wheel made by the same. The heating paint coating method uniformly form a heating paint layer on an object having a waved surface like in a steering wheel, and also facilely control a thickness of the heat-patterns. In addition, since it is possible to facilely control a position forming the heating paint layer, and a shape and thickness of the heating paint layer, the resistance division by regions is facilitated, and the loss of the heating paint is reduced, and also the processing cost is reduced.

### TECHNICAL FIELD

The present invention relates to a heating paint coating method and a steering wheel having a heating paint layer formed by the same.

### BACKGROUND ART

Generally, since a steering wheel of a car is exposed to an internal space of the car. A surface of the steering wheel has the same temperature as an indoor temperature of the car. Therefore, a surface temperature of the steering wheel is largely lowered in the winter, even though the steering wheel is not directly contacted with external air, and thus a driver feels chilly from the steering wheel, when driving the car.

Typically, an air conditioning system is provided at the car. If the driver controls an indoor temperature of the car using the air conditioning system, the surface temperature of the car is gradually increased according to the controlled indoor temperature.

However, since the air conditioning system generates hot wind using coolant, it takes a long time to heat the coolant to a desired temperature in order to generate the hot wind.

To solve the problem, there has been proposed a method in which a heating layer is formed on a surface of a steering wheel so as to control a surface temperature of the steering wheel. The heating layer is typically formed by coating and drying a heating paint on a surface to be coated.

However, in case of the steering wheel, since a surface to be coated has a circular shape, it is very difficult to uniformly coat the heating paint. Like in the steering wheel, if the surface to be coated is waved, it is impossible to uniformly control a thickness of the heating layer, and also it is difficult to coat a different amount of heating paint on each region of the steering wheel in order to regionally control a temperature of the steering wheel.

Furthermore, in case that the heating layer is formed by spraying, since the heating paint is sprayed on the peripheral areas as well as the surface to be coated, the paint consumption is increased.

### DISCLOSURE OF INVENTION

### Technical Problem

An object of the present invention is to provide a heating paint coating method and a steering wheel having a heating paint layer formed by the same.

### Solution to Problem

To achieve the object of the present invention, the present invention provides a heating paint coating method which includes filling a heating paint in an intagliated portion formed at a substrate; transferring the filled heating paint to an elastic pad; and transferring the heating paint to an object to be coated using the elastic pad containing the transferred heating paint.

Further, the present invention provides a steering wheel including a core part; a synthetic resin layer formed on an outer surface of the core part; and a heating paint layer formed on an outer surface of the synthetic resin layer by the heating paint coating method.

### Advantageous Effects of Invention

According to the present invention, it is possible to provide a heating paint coating method which can uniformly form the heating paint layer on an object having a waved surface, like a steering wheel of a car, and facilely control a thickness of the heating paint layer, and also it is possible to coat the surface and form various designs or patterns. In addition, since it is possible to facilely control a position forming the heating paint layer, and a shape and thickness of the heating paint layer, the resistance division by regions is facilitated, and the loss of the heating paint is reduced, and also the processing cost is reduced.

### BRIEF DESCRIPTION OF DRAWINGS

The above and other objects, features and advantage of the present invention will be apparent from the following description of preferred embodiments given in conjunction with the accompanying drawings, in which:

FIG. 1 is a schematic view showing each process of a heating paint coating method.

FIG. 2 is a view of a steering wheel.

FIG. 3 is a cross-sectional view of a steering wheel according to the present invention, which is taken along a line A-A′ of FIG. 2.

FIG. 4 is a cross-sectional view of another steering wheel according to the present invention, which is taken along a line A-A′ of FIG. 2.

FIG. 5 is a cross-sectional view of yet another steering wheel according to the present invention, which is taken along a line A-A′ of FIG. 2.

### BEST MODE FOR CARRYING OUT THE INVENTION

The present invention relates to a heating paint coating method which includes filling a heating paint in an intagliated portion formed at a substrate; transferring the filled heating paint to an elastic pad; and transferring the heating paint to an object to be coated using the elastic pad containing the transferred heating paint.

Hereinafter, a heating paint coating method according to the present invention will be described with reference to accompanying drawings.

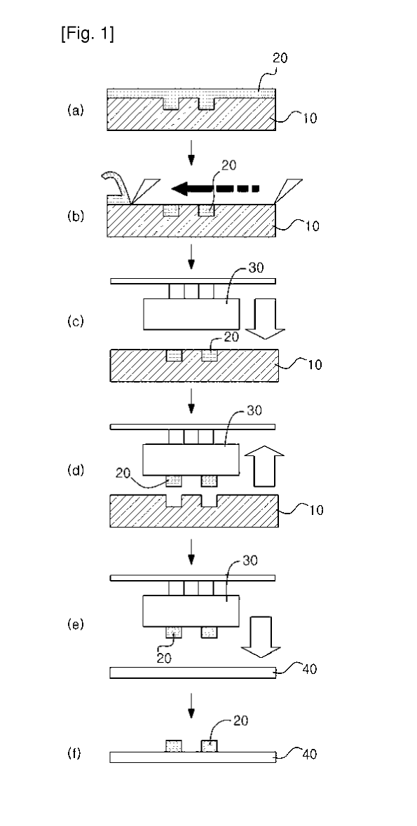

FIG. 1 is a schematic view showing each process of a heating paint coating method.

According to the present invention, the filling of the heating paint in the intagliated portion formed at the substrate may include (1) filling the heating paint in the intagliated portion by coating the heating paint on a surface of the substrate 10 having the intagliated portion ((a) of FIG. 1); and (2) removing the heating paint coated on the surface of the substrate except the heating paint filled in the intagliated portion ((b) of FIG. 1).

As shown in (a) of FIG. 1, in the step (1), the heating paint is filled in the intagliated portion by coating the heating paint on the surface of the substrate having the intagliated portion. Herein, a kind of used substrate is not particularly limited, and for example, a hardened steel or a metal plate having a polymer coating may be used as the substrate.

In the substrate, the intagliated portion may be formed to have a certain position, shape and thickness corresponding to a desired position, shape and thickness of a heating paint layer.

Preferably, the intagliated portion has a depth less than 50 μm, more preferably, 30 μm. If the depth of the intagliated portion is more than 50 μm, the heating paint filled in the intagliated portion may be not smoothly transferred to the elastic pad. Meanwhile, the lower limit of the depth of the intagliated portion is not restricted particularly, and for example, the depth may be properly adjusted in a desired extent that is more than 0 μm.

In the step (1), a general heating paint used in the art may be used as the heating paint filled in the intagliated portion, but it is preferable to use a heating paint containing carbon nanotube.

The carbon nanotube contained in the heating paint according to the present invention has excellent electrical and thermal conductivity. A kind of carbon nanotube used in the present invention is not limited particularly. For example, single-walled carbon nanotube, double-walled carbon nanotube and multi-walled carbon nanotube may be used. In the present invention, all kinds of carbon nanotube may be used regardless of a shape, shape and diameter thereof.

The heating paint used in the present invention may further contain silver particles. The silver particle functions to reduce contact resistance between the carbon nanotubes, thereby increasing the electrical conductivity and control a resistance value. In the composition of the present invention, preferably, a covalent bond is formed between the silver particle and the carbon nanotube through oxidation and/or sub-situation reaction. As described above, if the covalent bond is formed between the silver particle and the carbon nanotube, it is possible to obtain a resistance coefficient of almost 0, compared with a case that the silver particle is simply mixed with the carbon nanotube or the silver particle is absorbed in the carbon nanotube by physical gravity. Thus, the heating paint can continuously maintain its own performance.

A content of the silver particle may be 300˜700 parts by weight with respect to 100 parts by weight of the carbon nanotube. If the content of the silver particle is less than 300 parts by weight, the resistance may be excessively increased and thus heating effect may be deteriorated. If the content of the silver particle is more than 700 parts by weight, separation or settling of the silver particle may occur.

In the present invention, the heating paint may further contain a binder. A content of the binder may be 50˜300 parts by weight, preferably, 50˜150 parts by weight with respect to 100 parts by weight of the carbon nanotube.

A kind of the binder is not limited particularly, and thus a general binder such as, but not limited to, acrylic resin may be used.

In the present invention, the heating paint may further contain a solvent. A kind of the solvent is not limited particularly. For example, the solvent may be one or more selected from the group consisting of water, ethanol, methylethylketone, isopropyl alcohol, toluene, N-methyl pyrrolidone, ethyl acetate, butyl cellusolve and the like.

In the present invention, a content of the solvent is not limited particularly. The content of the solvent is controlled appropriately according to dispersibility of the carbon nanotube and the silver particle, and viscosity of the composition.

A viscosity of the heating paint of the present invention may be within an extent of 10,000˜50,000 cps, preferably, 10,000˜30,000 cps. The viscosity of the heating paint may be regulated using the solvent (thinner) and the like so as to enhance workability such as the filling, transferring and coating of the heating paint.

In the present invention, a manufacturing method of the heating paint is not limited particularly, and for example, includes (a) covalently binding the carbon nanotube and the silver particle; (b) preparing a mixture by mixing the covalently bound carbon nanotube and silver particle with a binder and a solvent; and (c) regulating a viscosity of the mixture.

In the step (a), a method of covalently binding the carbon nanotube and the silver particle is not limited particularly. For example, the method includes acid-treating the carbon nanotube, reduction (neutralization)-treating the carbon nanotube, and reacting the carbon nanotube and the silver particle.

More detailedly, in the method, the carbon nanotube is put into an acidic solution so as to perform the acid treatment. Herein, A kind of the acidic solution is not limited particularly. For example, the acidic solution includes hydrochloric acid aqueous solution, nitric acid aqueous solution, sulfuric acid aqueous solution and the like. Due to the acid treatment, a carboxyl group is introduced into the carbon nanotube, and the carbon nanotube has an acidity. Conditions of the acidic solution used in the present invention, such as pH, treating temperature and treating time, are not limited particularly, but may be selected properly according to a kind or content of the carbon nanotube.

In the present invention, a reduction reaction of the carbon nanotube may be performed after the acid treatment. Due to the reduction reaction, the electrical conductivity of the carbon nanotube, which may be deteriorated by the acid treatment, is compensated. In the present invention, a method of performing the reduction reaction is not limited particularly. In the method, for example, the acid-treated carbon nanotube may be neutralized by adding a base. Herein, a kind of the base is not limited particularly, and thus the base generally used in the art can be used. Meanwhile, in the present invention, the acid-treated carbon nanotube treated by the reduction reaction, or the acidic solution contained the carbon nanotube may be controlled to have a pH of 6 or more, preferably, about 7.

In the present invention, if necessary, the reaction between the carbon nanotube and the silver particle may be performed through a process of filtering the carbon nanotube in the neutralized solution. Herein, a method of performing the reaction is not limited particularly. For example, the reaction may be performed by stirring the carbon nanotube and the silver particle in a proper solvent. A kind of the solve used in this process is not limited particularly. For example, the same solvent as that contained in the above-mentioned heating paint composition may be used. Further, reaction conditions between the carbon nanotube and the silver particle, such as reaction time and temperature, are not limited particularly, if the covalent bond can be formed between the carbon nanotube and the silver particle.

Furthermore, in the step (c), the viscosity can be regulated by using a thinner. For example, the thinner may include the same solvent as that contained in the above-mentioned heating paint composition.

In the step (1), if the heating paint is coated on the surface of the substrate, the heating paint is filled in the intagliated portion formed at substrate.

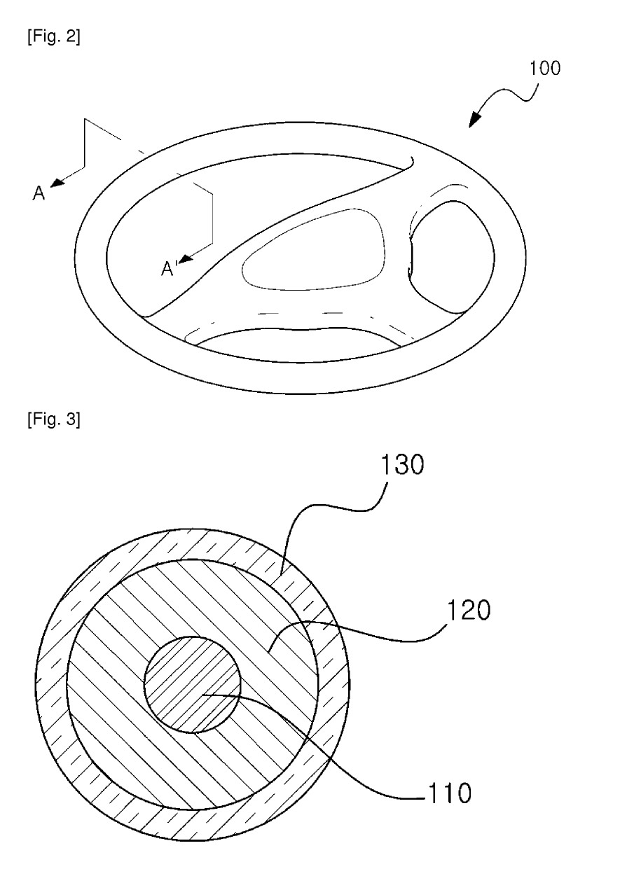

In the step (2) which removes the heating paint formed on the surface of the substrate 1 except that filled in the intagliated portion, as shown in (b) of FIG. 2, a blade may be used to remove the heating paint. For example, if the blade is closely contacted with the surface of the substrate and then moved in one direction, the heating paint is removed except that filled in the intagliated portion.

In the transferring of the filled heating paint to the elastic pad, ((c) and (d) of FIG. 1), a kind of the elastic pad is not limited particularly. Preferably, the elastic pad is formed of an elastic soft rubber or an elastomer. More detailedly, the elastic pad is made of silicone or silicone polymer.

In the transferring of the filled heating paint to the elastic pad, as shown in (c) of FIG. 1, the elastic pad and the substrate are contacted with each other, such that the elastic pad is contacted with the heating paint filled in the intagliated portion. Then, as shown in (d) of FIG. 1, the elastic pad is separated from the substrate. In this process, when the elastic pad is contacted with and separated from the substrate having the intagliated portion, the heating paint is transferred to the elastic pad by flowing of compressed air and the like.

The contacting and separating of the elastic pad and the substrate may be carried out by descending and ascending the elastic pad or the substrate.

In the transferring of the heating paint to the object 40 to be coated using the elastic pad containing the transferred heating paint, ((e) and (f) of FIG. 1), the transferring of the heating paint to the object 40 to be coated is may be performed by contacting the elastic pad and the object to be coated, as shown in (e) of FIG. 1, and then separating them from each other at a desired speed. Then, as shown in (f) of FIG. 1, the heating paint on the surface of the elastic pad is transferred to the object to be coated by the flow of compressed air and the like.

Since the heating paint is coated on the object to be coated using the above-mentioned method, it is possible to uniformly form a heating paint layer on an object having a waved surface and also facilely control a thickness of the heating paint layer, and it is further possible to facilely form the heating paint layer having a desired design or pattern and also facilely coat the whole surface of the object to be coated.

In addition, since a forming position, a shape and a thickness of the heating paint layer can be facilely controlled, the resistance division by regions is facilitated, and the loss of the heating paint is reduced, and also the processing cost is reduced.

Herein, a kind of the object to be coated is not limited particularly. The present invention can be applied any fields which need the heating phenomenon using the heating paint, such as a steering wheel of a car. But it is not limited to this example.

The heating paint coating method according to the present invention may further includes drying the heating paint transferred to the object to be coated. The drying may be carried out for 10˜60 minutes, preferably 15˜30 minutes at a temperature of 70˜40° C., preferably 90˜120° C. Particularly, in the present invention, a drying time may be changed properly according to a drying temperature. For example, if that the drying temperature is set to 90° C., the drying time is preferably about 30 minutes, and if that the drying temperature is set to 120° C., the drying time is preferably 15 minutes.

Furthermore, the present invention relates to a steering wheel including a core part; a synthetic resin layer formed on an outer surface of the core part; and a heating paint layer formed on an outer surface of the synthetic resin layer by the above-mentioned heating paint coating method.

In the present invention, a shape of the steering wheel is not limited particularly, and thus the steering wheel may have various shapes which can be applied to the art. For example, the steering wheel may be formed into a shape of FIG. 2. FIG. 3 is a cross-sectional view of the steering wheel according to the present invention, which is taken along a line A-A′. The steering wheel 400 includes a core part 110; a synthetic resin layer 120 formed on an outer surface of the core part; and a heating paint layer 130 formed on an outer surface of the synthetic resin layer.

The core part 110 is located at a center portion of the cross-sectional view of the steering wheel. A material of the core part is not limited particularly, and thus a typical core part used in the art may be used as it is.

The synthetic resin layer 120 is formed on the outer surface of the core part. A kind of synthetic resin used in the synthetic resin layer is not limited particularly, and a typical synthetic resin used in the art may be used. For example, the synthetic resin includes acrylonitrile butadiene styrene copolymer (ABS) resin, polyurethane and expanded propylene.

Herein, a thickness of the synthetic resin layer is not limited particularly, but may be properly selected according to its application purpose.

The heating paint layer 130 of the present invention is formed on the outer surface of the synthetic resin layer.

The heating paint layer is formed of the heating paint containing the carbon nanotube and the silver particle, as described above.

Moreover, the heating paint layer may be formed by the same method as the heating paint coating method.

By forming the heating paint layer using the above coating method, the heating paint layer can be uniformly formed on the outer surface of the synthetic resin layer having a waved surface, a thickness of the heating paint layer can be facilely controlled, and also the whole surface can be coated. In addition, the resistance division by regions is facilitated, and the loss of the heating paint is reduced, and also the processing cost is reduced.

The thickness of the heating paint layer is not limited particularly, but may be 50 μm or less, preferably 30 μm or less. The thickness of the heating paint layer is associated with the resistance value. When the thickness of the heating paint layer is controlled within the above extent, the resistance value is minimized, and the heating paint shows excellent heating performance.

The heating paint layer of the present invention may further include an electrode (not shown) connected with the heating paint layer. The electrode is connected through a wire to the heating paint layer. If power is supplied to the heating paint layer through the electrode, current is flowed through the conductive particles (carbon nanotube and silver particle) contained in the heating paint layer, and heat is generated by the resistance thereof, thereby providing warmth to the steering wheel.

Especially, even through particles of the carbon nanotube are spaced apart from each other in a desired distance, they can form an electrical network through which the electrical power is supplied, and thus only a small amount of the carbon nanotube can be used. Further, since the carbon nanotube is hardly gathered at a certain position due to excellent dispersibility, it is possible to obtain uniform heating distribution without heat collecting phenomenon.

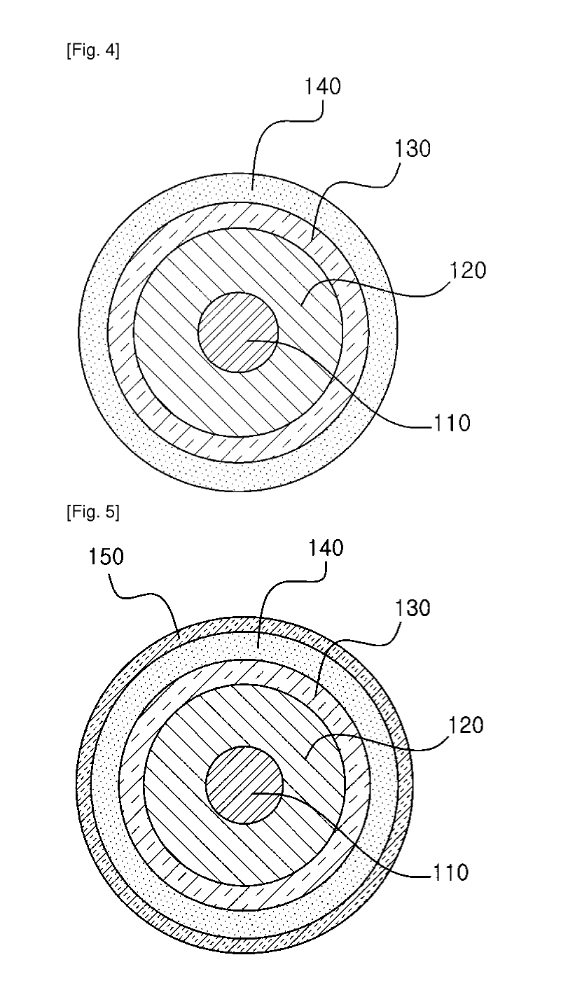

As shown in FIG. 4, the steering wheel of the present invention may further include a cover layer 140 formed on an outer surface of the heating paint layer 130.

The cover layer may be formed of wood, leather or a wood pattern layer.

A thickness of the cover layer is not limited particularly, but may be properly selected according to its application purpose.

Furthermore, as shown in FIG. 5, the steering wheel of the present invention may further include a surface coating layer 150 formed on an outer surface of the cover layer 140. The surface coating layer functions to prevent damage of the steering wheel. Particularly, in case that the cover layer is formed of the wood or the wood pattern layer, the surface coating layer can be efficiently applied.

The surface coating layer may be formed of a transparent material through which the cover layer formed on an inner surface of the surface coating layer is facilely shown to the outside. The transparent material may be one or more selected from the group consisting of fluororesin, urethane resin, acrylic resin and the like. Further, a coating film containing organic silicone compound and titanium oxide may be used in the present invention.

### Mode for the Invention

Hereinafter, the embodiments of the present invention will be described in detail.

### First Embodiment

The heating paint was manufactured by covalently binding 100 parts by weight of carbon nanotube and 500 parts by weight of silver particle and then dispersing them in 100 parts by weight of a binder and 300 parts by weight of a solvent. Herein, a specific gravity of the heating paint was 1.8, and a viscosity thereof was 15,000 cps. 100 parts by weight of the manufacture heating paint was mixed with 80 parts by weight of a thinner in order to regulate the viscosity of the heating paint. The attenuated heating paint was coated on a substrate having a polymer coating of 20 μm, in which an intagliated portion is formed, and then the heating paint coated on the substrate was removed by using a blade, except the heating paint filled in the intagliated portion. And the heating paint filled in the intagliated portion was transferred to an elastic pad made of silicone, and the heating paint transferred to the elastic pad was transferred to an outer surface of a steering wheel including a core part and a synthetic resin layer, and then a heating paint layer was formed by drying the heating paint transferred to the steering wheel. After that, an outer surface of the heating paint layer formed on the steering wheel was covered with leather. A resistance of the steering wheel measured by a general resistance measuring device was 2˜3Ω.

While the present invention has been described with respect to the specific embodiments, it will be apparent to those skilled in the art that various changes and modifications may be made without departing from the spirit and scope of the invention as defined in the following claims.

1. A heating paint coating method for steering wheel comprising:
filling a heating paint in an intagliated portion formed at a substrate;
transferring the filled heating paint to an elastic pad; and
transferring the heating paint to an object to be coated using the elastic pad containing the transferred heating paint.

2. The heating paint coating method according to claim 1, wherein the filling of the heating paint in the intagliated portion formed at the substrate comprises:
(1) filling the heating paint in the intagliated portion by coating the heating paint on a surface of the substrate having the intagliated portion; and
(2) removing the heating paint coated on the surface of the substrate except the heating paint filled in the intagliated portion.

3. The heating paint coating method according to claim 1, wherein a depth of the intagliated portion is controlled to 50 μm or less.

4. The heating paint coating method according to claim 1, wherein the heating paint contains carbon nanotube.

5. The heating paint coating method according to claim 4, wherein the heating paint further contains silver particle.

6. The heating paint coating method according to claim 5, wherein the silver particle is covalently bound to the carbon nanotube.

7. The heating paint coating method according to claim 4, wherein the heating paint further contains a binder.

8. The heating paint coating method according to claim 4, wherein the heating paint further contains a solvent.

9. The heating paint coating method according to claim 1, wherein the elastic pad is formed of silicone or silicone polymer.

10. The heating paint coating method according to claim 1, further comprising drying the heating paint transferred to the object to be coated.

11. A steering wheel comprising:
a core part;
a synthetic resin layer formed on an outer surface of the core part; and
a heating paint layer formed on an outer surface of the synthetic resin layer by the method according to claim 1.

12. The steering wheel according to claim 11, wherein a thickness of the heating paint layer is less than 50 μm or less.

13. The steering wheel according to claim 11, further comprising an electrode connected with the heating paint layer.

14. The steering wheel according to claim 11, further comprising a cover layer formed on an outer surface of the heating paint layer.

15. The steering wheel according to claim 14, further comprising a surface coating layer formed on an outer surface of the cover layer.
